(19) United States
(12) Patent Application Publication
(10) Pub. No.: US 2019/0145858 A1
(43) Pub. Date: May 16, 2019

(54) FINE-PARTICLE NUMBER DETECTOR

(71) Applicant: NGK INSULATORS, LTD., Nagoya-City (JP)

(72) Inventors: Keiichi KANNO, Nagoya-City (JP); Kazuyuki Mizuno, Nagoya-City (JP); Hidemasa Okumura, Nagoya-City (JP)

(73) Assignee: NGK INSULATORS, LTD., Nagoya-City (JP)

(21) Appl. No.: 16/243,389

(22) Filed: Jan. 9, 2019

Related U.S. Application Data
(63) Continuation of application No. PCT/JP2017/024943, filed on Jul. 7, 2017.

(30) Foreign Application Priority Data
Jul. 12, 2016 (JP) 2016-137414

(51) Int. Cl. G01M 15/10; B01D 39/20; B01D 46/24

(52) U.S. Cl. CPC G01M 15/102; B01D 39/2068; B01D 2046/2481; B01D 2279/30; B01D 46/2418

(57) ABSTRACT

A fine-particle number detector includes a filter selectively removing, from among fine particles in car exhaust gas introduced into a gas passage pipe, ultrafine particles not larger than a predetermined particle size that is previously set as an upper limit within a range of 25 nm or less, a charge adding device adding charges to the fine particles in the exhaust gas having passed through the filter, and producing charged fine particles and a detection device detecting the number of fine particles in the exhaust gas having passed through the filter on the basis of an amount of charges of the charged fine particles or an amount of charges having not been added to the fine particles.

### BACKGROUND OF THE INVENTION

### 1. Field of the Invention

The present invention relates to a fine-particle number detector.

### 2. Description of the Related Art

In detecting the number of fine particles in car exhaust gas, it is generally known to exclude ultrafine particles (fine particles having particle sizes of 23 nm or smaller) from a measurement target in accordance with the definitions of PMP (Particle Measurement Programme) (see NPL 1). In PTLs 1 and 2, for example, measurement of the number of fine particles in the exhaust gas is performed by measuring the particle number per particle size, and by calculating the number of fine particles except for ultrafine particles, particularly fine particles having particle sizes of 20 nm or smaller. On the other hand, in a known example of fine-particle number detectors, as disclosed in Patent PTL 3, charges are added to fine particles in to-be-measured gas introduced into a housing, the fine particles added with the charges are captured, and the number of fine particles is measured on the basis of an amount of the charges on the captured fine particles.

### CITATION LIST

### Patent Literature

PTL 1: Japanese Unexamined Patent Application Publication No. 2014-199204

PTL 2: Japanese Unexamined Patent Application Publication No. 2012-117520

PTL 3: International Publication No. 2015/146456

### Non Patent Literature

NPL 1: Regulation No 83 of the Economic Commission for Europe of the United Nations (UNECE)⋅Uniform provisions concerning the approval of vehicles with regard to the emission of pollutants according to engine fuel requirements [2015/1038]

### SUMMARY OF THE INVENTION

In the fine-particle number detector disclosed in PTL 3, however, because the number of fine particles is measured without taking particle sizes into consideration, the number of ultrafine particles is also counted, thus causing a problem of degradation in measurement accuracy. In particular, when the temperature of car exhaust gas is low, there is a problem that a rate of ultrafine particles in total fine particles included in the exhaust gas increases and the degradation in measurement accuracy is more significant.

The present invention has been made to solve the above-described problems, and a primary object of the present invention is to detect the number of fine particles included in car exhaust gas with high accuracy regardless of the temperature of the car exhaust gas.

A fine-particle number detector according to the present invention includes:

a filter selectively removing, from among fine particles in car exhaust gas introduced into a gas passage pipe, ultrafine particles not larger than as a predetermined particle size that is previously set as an upper limit within a range of 25 nm or less,

a charge adding device adding charges to the fine particles in the exhaust gas having passed through the filter, and producing charged fine particles; and

a detection device detecting the number of fine particles in the exhaust gas having passed through the filter on the basis of an amount of charges of the charged fine particles or an amount of charges having not been added to the fine particles.

In the above fine-particle number detector, while car exhaust gas having been introduced into the gas passage pipe passes through the filter, the ultrafine particles among the fine particles in the exhaust gas are selectively removed. Charges are added to the fine particles in the exhaust gas having passed through the filter, and these particles become charged fine particles. The number of fine particles in the exhaust gas having passed through the filter is detected on the basis of an amount of charges of the charged fine particles or an amount of charges having not been added to the fine particles. The ultrafine particles are fine particles other than a measurement target. The appearance frequency of the ultrafine particles is low when the temperature of the exhaust gas is high (e.g., 200° C. or higher), but it increases at low temperature (e.g., 100° C. or lower) to such an extent as exhibiting a peak in particle size distribution of the fine particles. According to the present invention, since the ultrafine particles other than the measurement target are selectively removed by the filter in advance, the number of fine particles included as the measurement target in the car exhaust gas can be detected with high accuracy regardless of the temperature of the car exhaust gas.

In this Description, the “predetermined particle size” is just required to be a particle size previously set within the range of 25 nm or less, and it may be, for example, 25 nm, 23 nm, 20 nm, 15 nm, or 10 nm. The wording “selectively remove the ultrafine particles” stands for that, looking at penetration characteristics of the filter, the penetration coefficient of the ultrafine particles is lower than that of non-ultrafine particles (fine particles other than the ultrafine particles). It is assumed that the “charges” include positive charges, negative charges, and ions. The wording “detect the number of fine particles” stands for not only the case of measuring the number of fine particles, but also the case of determining whether the number of fine particles falls within a predetermined numerical range (e.g., whether the number of fine particles exceeds a predetermined threshold).

In the fine-particle number detector according to the present invention, the filter may be a honeycomb filter including many cells. With this feature, while the exhaust gas having been introduced into the gas passage pipe passes through the cells, the ultrafine particles in the exhaust gas are selectively adsorbed on cell walls due to the Brown motion. Therefore, the present invention can be realized with a comparatively simple structure.

In the above case, the charge adding device may include a dielectric electrode made of a wall between adjacent ones among the many cells on a downstream side in a flowing direction of the exhaust gas, and a discharge electrode and a ground electrode arranged with the dielectric layer interposed therebetween. With this feature, since the charge adding device and the filter are integral with each other, the present invention can be realized with a simpler structure. Alternatively, the charge adding device may have a structure that, looking at quadrangular cross-sections of four ones among the many cells, the four ones being consisted of vertically arranged two cells and horizontally arranged two cells, a discharge electrode is disposed in one of the two diagonally arranged cells, a ground electrode is disposed in the other cell, and the remaining two cells serve as gas flow paths. The electrodes (discharge electrode and ground electrode) disposed in the cells may be each disposed in a state sealing the cell, or as a film formed on an inner wall of the cell without sealing the cell.

In the fine-particle number detector according to the present invention, the filter may include slits, and an interval between the slits may be set to a range of not less than 0.01 mm and less than 0.2 mm. With these features, while the exhaust gas having been introduced into the gas passage pipe passes through the slits, the ultrafine particles in the exhaust gas are selectively adsorbed on walls defining the slits due to the Brown motion. Therefore, the present invention can be realized with a comparatively simple structure. The reason why the slit interval is set to be not less than 0.01 mm is to avoid a pressure loss from becoming too high, and the reason why the slit interval is set to be less than 0.2 mm resides in making the ultrafine particles under the Brown motion more easily adsorbed on the filter.

In the fine-particle number detector according to the present invention, the filter is preferably made of ceramic. Because ceramic has high heat resistance, the ceramic-made filter is suitable, for example, when the filter is heated to high temperature for thermally decomposing the fine particles adhering to the filter.

### BRIEF DESCRIPTION OF THE DRAWINGS

FIG. 1 is a sectional view schematically illustrating a structure of a fine-particle number detector 10.

FIG. 2 is a perspective view of a honeycomb filter 20. FIG. 3 is a graph plotting penetration characteristics of the honeycomb filter 20.

FIG. 4 is a partial rear view of the honeycomb filter 20.

FIG. 5 is a partial rear view of another example of the honeycomb filter 20.

FIG. 6 is a sectional view schematically illustrating a structure of a fine-particle number detector 110.

FIG. 7 is a perspective view of a filter 220 including slits 222.

FIG. 8 is a graph plotting penetration characteristics of the filter 220.

### DETAILED DESCRIPTION OF THE INVENTION

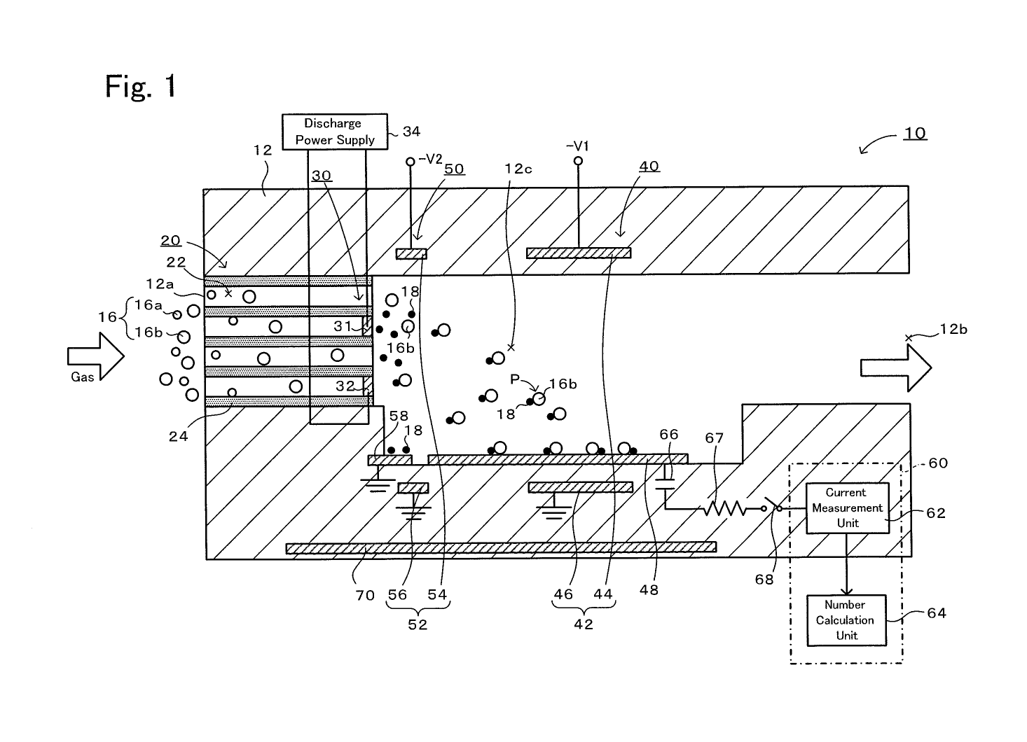

A preferred embodiment of the present invention will be described below with reference to the drawings. FIG. 1 is a sectional view schematically illustrating a structure of a fine-particle number detector 10.

The fine-particle number detector 10 is to measure the number of fine particles included in car exhaust gas. As illustrated in FIG. 1, the fine-particle number detector 10 includes a honeycomb filter 20, a charge adding unit 30, a capturing device 40, an extra-charge removing device 50, a number measurement device 60, and a heater 70, which are disposed in a gas passage pipe 12 made of ceramic. The gas passage pipe 12 includes a gas inlet 12a through which gas is introduced into the gas passage pipe 12, and a gas outlet 12b through which gas having passed through the gas passage pipe 12 is discharged.

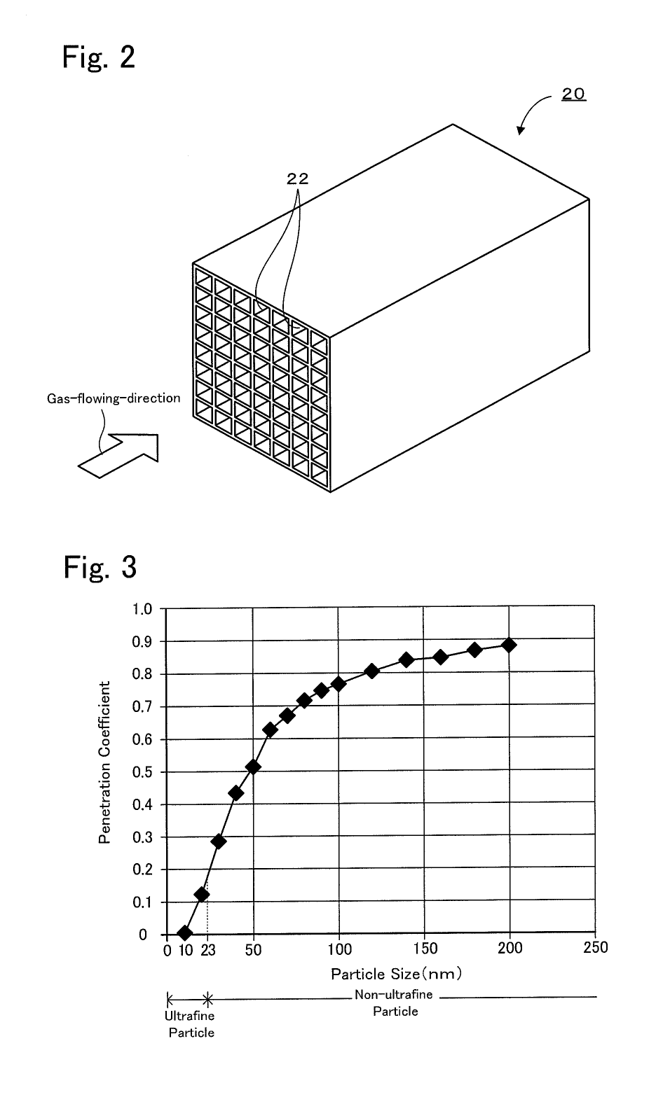

The honeycomb filter 20 is a honeycomb structure body and has many cells 22 penetrating through the honeycomb filter 20 along a gas flowing direction. A known honeycomb structure body (unsealed) serving as a base of a diesel particulate filter (DPF) can be used as the honeycomb filter 20. FIG. 2 is a perspective view of the honeycomb filter 20. In FIG. 2, the honeycomb filter 20 has a quadrangular sectional shape. However, the sectional shape of the honeycomb filter 20 is not particularly limited to the quadrangle, and it is just required to be matched with a sectional shape of the gas passage pipe 12. The honeycomb filter 20 has the function of selectively removing ultrafine particles 16a not larger than a predetermined particle size (here 23 nm) that is previously set as an upper limit within a range of 25 nm or less. Non-ultrafine particles 16b other than the ultrafine particles 16a are fine particles having comparatively large particle sizes, and many of them advance in the gas flowing direction and pass through the honeycomb filter 20 without being adsorbed on wall surfaces of the cells 22 because the Brown motion is moderate. On the other hand, many of the ultrafine particles 16a are diffused toward and adsorbed on the wall surfaces of the cells 22 instead of advancing in the gas flowing direction because the Brown motion is active. FIG. 3 plots penetration characteristics of the honeycomb filter 20 on an assumption that the honeycomb filter 20 is sized, for example, to have a wall thickness is 12 mil (about 305 μm), a cell density of 300 cells/square inch, and a length of 5.4 mm in the gas flowing direction. As seen from FIG. 3, the penetration coefficient of the ultrafine particles 16a is lower than that of the non-ultrafine particles 16b. More specifically, the penetration coefficient of the fine particles having the particle size of 10 nm is substantially zero, the penetration coefficient of the fine particles having the particle size of 23 nm is about 0.2, and the penetration coefficient of the fine particles having the particle sizes of 50 nm or more is 0.5 or more. Thus, the honeycomb filter 20 selectively removes the ultrafine particles 16a. Part of the non-ultrafine particles 16b is also removed by the honeycomb filter 20. However, conversion to the number of non-ultrafine particles 16b actually included in the exhaust gas can be performed by correcting the particle number, which has been measured by the number measurement device 60, in consideration of the amount (loss) of non-ultrafine particles 16b removed by the honeycomb filter 20.

The honeycomb filter 20 may be made of ceramic or metal, but it is preferably made of ceramic. The reason is that the honeycomb filter 20 made of ceramic has higher heat resistance and is more suitable for the case where it is heated to high temperature by the later-described heater 70 to thermally decompose the fine particles made of mainly carbon. It deems to be sufficient that the temperature necessary for thermally decomposing the fine particles is, for example, 600° C. or higher. The ceramic is preferably at least one selected from among a group consisting of alumina, silicon nitride, mullite, zirconia, cordierite, and magnesia. When the honeycomb filter 20 is made of metal, similar effects can also be obtained by selecting a metal having high heat resistance, such as stainless steel.

A surface roughness Ra of gas passage surfaces in the honeycomb filter 20 is not limited to a particular value, but it is preferably 0.1 μm or more. The reason is that, by so setting the surface roughness Ra, a surface area increases and the amount of fine particles adhering to the gas passage surfaces increases, thus making it possible to prolong a time until clogging occurs, and hence to improve durability of the honeycomb filter 20. A material constituting the honeycomb filter 20 is a porous body including closed pores. With use of such a material, because heat capacity of the honeycomb filter 20 itself is reduced, a time necessary for heating the honeycomb filter 20 to a predetermined temperature is shortened when the fine particles adhering to the honeycomb filter 20 are thermally decomposed using the later-described heater 70, whereby a particle number counter having good maintainability can be realized. The porosity is preferably as high as possible in consideration of the filter performance. However, if the porosity is too high, there is a possibility that mechanical strength may reduce. Thus, the porosity is preferably set to be 80% or less.

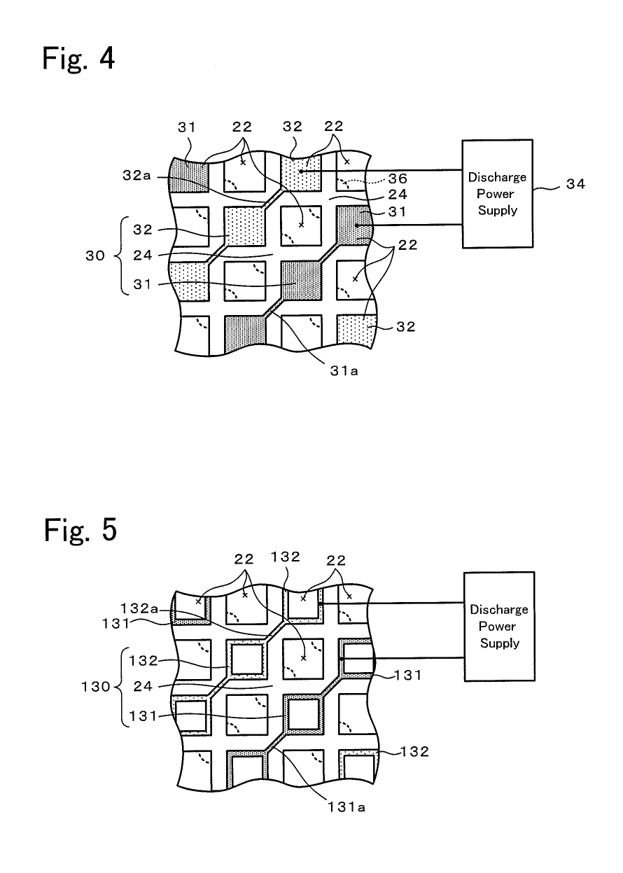

As illustrated in FIG. 1, the charge adding unit 30 is assembled in a surface (rear surface) of the honeycomb filter 20 on the downstream side in the gas flowing direction. The charge adding unit 30 includes first conductive plugs 31 and second conductive plugs 32. FIG. 4 is a partial rear view of the honeycomb filter 20. The first and second conductive plugs 31 and 32 are formed by alternately sealing the many cells 22, which are arrayed in vertical and horizontal directions, using a conductive material (e.g., metal). In FIG. 4, looking at the cells 22 arrayed in the horizontal direction, those cells are repeatedly arrayed in order of the cell 22 not sealed, the cell 22 sealed by the first conductive plug 31, the cell 22 not sealed, and the cell 22 sealed by the second conductive plug 32. Looking at the cells 22 arrayed in the vertical direction, those cells are repeatedly arrayed in order of the cell 22 sealed by the first conductive plug 31, the cell 22 not sealed, the cell 22 sealed by the second conductive plug 32, and the cell 22 not sealed. The plurality of first conductive plugs 31 successively arranged in a diagonal direction (i.e., a direction obliquely orienting from below to upper right) are electrically interconnected via a first conductive line 31a obliquely continuously extending through partition walls 24 of the honeycomb filter 20. Similarly, the plurality of second conductive plugs 32 successively arranged in the diagonal direction (i.e., the direction obliquely orienting from below to upper right) are electrically interconnected via a second conductive line 32a obliquely continuously extending through the partition walls 24. Each pair of the first conductive plug 31 and the second conductive plug 32 opposing to each other with the partition wall 24 interposed therebetween constitutes the charge adding unit 30 together with the partition wall 24 between both the plugs 31 and 32. In other words, the charge adding unit 30 is constituted by the first conductive plugs 31 serving as discharge electrodes, the second conductive plugs 32 serving as ground electrodes, and the partition walls 24 serving as dielectric layers and existing between both the plugs. When power is supplied from a low-frequency or direct-current discharge power supply 34 to generate a high potential difference between the first conductive plug 31 and the second conductive plug 32, oxygen molecules, water molecules, and so on in the exhaust gas are ionized due to aerial discharge, and ions (charges) are generated. Examples of the aerial discharge include corona discharge, dielectric barrier discharge, and both of corona discharge and dielectric barrier discharge. In FIG. 4, a discharge region 36 is schematically denoted by a dotted line defining a sectoral shape. While the exhaust gas passes across the aerial discharge, the charges 18 are added to the non-ultrafine particles 16b and these particles become charged fine particles P, as illustrated in FIG. 1.

The capturing device 40 is a device for capturing the charged fine particles P, and is disposed in a hollow portion 12c of the gas passage pipe 12. The capturing device 40 includes an electric-field generator 42 and a capturing electrode 48. The electric-field generator 42 includes a negative electrode 44 embedded in a wall of the hollow portion 12c, and a positive electrode 46 embedded in a wall opposing to the negative electrode 44. The capturing electrode 48 is exposed at the wall of the hollow portion 12c in which the positive electrode 46 is embedded. A negative potential −V1 is applied to the negative electrode 44 of the electric-field generator 42, and a ground potential Vss is applied to the positive electrode 46. A level of the negative potential −V1 ranges from an order of −mV to several tens −V. On those conditions, an electric field directing from the positive electrode 46 toward the negative electrode 44 generates inside the hollow portion 12c. Accordingly, the charged fine particles P entering the hollow portion 12c are attracted to the positive electrode 46 by the action of the generated electric field and are captured by the capturing electrode 48 that is disposed midway a migration path of the charged fine particles P toward the positive electrode 46.

The extra-charge removing device 50 is a device for removing the charges 18 having not been added to the fine particles 16, and is disposed in the hollow portion 12c at a position before the capturing device 40 (on the upstream side in the gas flowing direction). The extra-charge removing device 50 includes an electric-field generator 52 and a removing electrode 58. The electric-field generator 52 includes a negative electrode 54 embedded in a wall of the hollow portion 12c, and a positive electrode 56 embedded in a wall opposing to the negative electrode 54. The removing electrode 58 is exposed at the wall of the hollow portion 12c in which the positive electrode 56 is embedded. A negative potential −V2 is applied to the negative electrode 54 of the electric-field generator 52, and the ground potential Vss is applied to the positive electrode 56. A level of the negative potential −V2 ranges from an order of −mV to several tens −V. An absolute value of the negative potential −V2 is smaller than that of the negative potential −V1 applied to the negative electrode 44 of the capturing device 40 by an order of magnitude or more. On those conditions, a weak electric field directing from the positive electrode 56 toward the negative electrode 54 generates. Accordingly, ones among the charges 18 generated in the charge adding unit 30 due to the aerial discharge, those ones being not added to the fine particles 16, are attracted toward the positive electrode 56 by the action of the weak electric field and are discarded to the GND through the removing electrode 58 that is disposed midway a migration path of the charges 18 toward the positive electrode 56.

The number measurement device 60 is a device for measuring the number of fine particles 16 on the basis of the amount of charges 18 of the charged fine particles P having been captured, and it includes a current measurement unit 62 and a number calculation unit 64. Between the current measurement unit 62 and the capturing electrode 48, a capacitor 66, a resistor 67, and a switch 68 are connected in series successively from the side close to the capturing electrode 48. The switch 68 is preferably a semiconductor switch. When the switch 68 is turned on and the capturing electrode 48 and the current measurement unit 62 are electrically connected to each other, a current generated by the charges 18, which are added to the charged fine particles P adhering to the capturing electrode 48, is transmitted, as a transient response, to the current measurement unit 62 through a serial circuit that is constituted by the capacitor 66 and the resistor 67. An ordinary ammeter can be used as the current measurement unit 62. The number calculation unit 64 calculates the number of charged fine particles P on the basis of a current value obtained from the current measurement unit 62.

The heater 70 is embedded in the wall of the hollow portion 12c where the capturing electrode 48 is disposed. Power is supplied to the heater 70 from a not-illustrated power supply when the charged fine particles P captured by the capturing electrode 48 are to be burnt to refresh the capturing electrode 48. The heater 70 is further used when the number of fine particles is to be measured in a state free from the influences of macromolecular hydrocarbons called SOF (Soluble Organic Fraction).

An usage example of the fine-particle number detector 10 will be described below. When measuring fine particles included in car exhaust gas, the fine-particle number detector 10 is attached in an engine exhaust pipe. At that time, the fine-particle number detector 10 is attached such that the exhaust gas is introduced into the gas passage pipe 12 from the gas inlet 12a of the fine-particle number detector 10 and is discharged from the gas outlet 12b.

As described above, the fine particles 16 are classified into the ultrafine particles 16a and the non-ultrafine particles 16b, and the ultrafine particles 16a are not the measurement target in accordance with the definitions of PMP. The appearance frequency of the ultrafine particles 16a is low when the temperature of the exhaust gas is high (e.g., 200° C. or higher), but it increases at low temperature (e.g., 100° C. or lower) to such an extent as exhibiting a peak in particle size distribution of the fine particles 16. Furthermore, the heater 70 is used to remove the particles adhering to the honeycomb filter 20. With the function of removing the particles adhering to the honeycomb filter 20, a fine particle counter having good maintainability can be realized.

While the exhaust gas having been introduced into the gas passage pipe 12 from the gas inlet 12a passes through the honeycomb filter 20, the ultrafine particles 16a among the fine particles 16 included in the exhaust gas are selectively removed. On the other hand, the charges 18 are generated due to the aerial discharge in the charge adding unit 30. The generated charges 18 are released to the downstream side of the honeycomb filter 20 in the gas flowing direction. The fine particles 16 (mainly the non-ultrafine particles 16b) having passed through the honeycomb filter 20 are mixed with the charges 18 released to the downstream side of the honeycomb filter 20 in the gas flowing direction, and then enter the hollow portion 12c after being added with the charges 18 and becoming the charged fine particles P. The charged fine particles P pass, as they are, through the extra-charge removing device 50 in which the electric field is weak and a length of the removing electrode 58 is shorter, i.e., 1/20 to 1/10, in comparison with that of the hollow portion 12c, and then reach the capturing device 40. The charges 18 having not been added to the fine particles 16 also enter the hollow portion 12c. Those charges 18 are attracted to the positive electrode 56 of the extra-charge removing device 50 although the electric field is weak, and are discarded to the GND through the removing electrode 58 that is disposed midway the migration path of the charges 18 toward the positive electrode 56. Thus, most of the unwanted charges 18 having not been added to the fine particles 16 do not reach the capturing device 40.

Upon reaching the capturing device 40, the charged fine particles P are attracted to the positive electrode 46 and are captured by the capturing electrode 48 that is disposed midway the migration path of the charged fine particles P toward the positive electrode 46. A current generated by the charges 18 of the charged fine particles P adhering to the capturing electrode 48 is transmitted, as a transient response, to the current measurement unit 62 of the number measurement device 60 through the serial circuit that is constituted by the capacitor 66 and the resistor 67.

The relation between a current I and a charge amount q is expressed by I=dq/(dt) or q=ƒIdt. In view of that relation, the number calculation unit 64 integrates (accumulates) a current obtained from the current measurement unit 62 for a time in which the switch 68 is turned on (i.e., a switch-on time), thereby determining an integral value of the current value (i.e., an accumulated charge amount). After lapse of the switch-on time, a total charge number (number of captured charges) is determined by dividing the amount of accumulated charges by an elementary charge, and the number of captured charges is divided by an average value of charge numbers added to each fine particle 16. Thus, the number of fine particles 16 adhering to the capturing electrode 48 for a certain time (e.g., 5 to 15 sec) can be obtained. The number calculation unit 64 can calculate the number of fine particles 16 adhering to the capturing electrode 48 for a predetermined period (e.g., 1 to 5 min) by repeating the calculation of counting the number of fine particles 16 for the certain time, and by integrating calculated values for the predetermined period. Furthermore, utilizing the transient response through the capacitor 66 and the resistor 67 makes it possible to measure even a small current, and to detect the number of fine particles 16 with high accuracy. For example, by using the resistor 67 having a large resistance value and increasing the time constant, a small current can be measured if the small current is at a level of pA (pico-ampere) or nA (nano-ampere). The capturing electrode 48 is refreshed on a timely basis by supplying power to the heater 70 and burning the fine particles 16 captured by the capturing electrode 48.

The number of fine particles calculated by the number calculation unit 64 represents the number of fine particles 16 (mainly the non-ultrafine particles 16b) after having passed through the honeycomb filter 20. Although the ultrafine particles 16a other than the measurement target are selectively removed by the honeycomb filter 20 while the exhaust gas passes through the honeycomb filter 20, part of the non-ultrafine particles 16b as the measurement target is also removed by the honeycomb filter 20. Furthermore, the non-ultrafine particles 16b having entered the sealed cells 22 in the honeycomb filter 20 do not pass through the honeycomb filter 20. In consideration of the above points, the number of fine particles calculated by the number calculation unit 64 is not the true number of fine particles, but the apparent number of fine particles. A value close to the true number of fine particles can be determined by performing correction in a manner of compensating for not only the amount (loss) of non-ultrafine particles 16b captured by the honeycomb filter 20, but also the number of non-ultrafine particles 16b having entered the sealed cells 22. When the honeycomb filter 20 has the penetration characteristics illustrated in FIG. 3, for example, the value close to the true number of fine particles may be determined by determining an average value of the penetration coefficients of the non-ultrafine particles 16b, dividing the apparent number of fine particles by the average value, and by dividing a resulting value by a rate of the number of unsealed cells 22 with respect to the total number of cells 22.

The correspondence relation between components in this embodiment and components in the present invention is as follows. The honeycomb filter 20 in this embodiment corresponds to a filter in the present invention, and the charge adding unit 30 corresponds to a charge adding device. The capturing device 40 and the number measurement device 60 correspond to a detection device in the present invention.

According to the embodiment described in detail above, the number of non-ultrafine particles 16b included as the measurement target in car exhaust gas can be detected with high accuracy regardless of the temperature of the exhaust gas. More specifically, the appearance frequency of the ultrafine particles 16a other than the measurement target is low when the temperature of the exhaust gas is high (e.g., 200° C. or higher), but it increases at low temperature (e.g., 100° C. or lower). In the embodiment, however, since the ultrafine particles 16a are selectively removed by the honeycomb filter 20 in advance, the number of ultrafine particles 16a is hardly counted in the value close to the true number of fine particles, which is finally calculated. Therefore, the number of fine particles included as the measurement target in car exhaust gas can be detected with high accuracy regardless of the temperature of the exhaust gas.

Furthermore, because of using the honeycomb filter 20, the present invention can be realized with a comparatively simple structure. In particular, since the charge adding unit 30 and the honeycomb filter 20 are constituted in an integral structure, the present invention can be realized with a simpler structure.

It is needless to say that the present invention is not limited to the above-described embodiment, and that the present invention can be implemented in various forms insofar as falling within the technical scope of the present invention.

For instance, in the above-described embodiment, the first conductive plugs 31 serving as discharge electrodes and the second conductive plugs 32 serving as ground electrodes are disposed as the charge adding unit 30 in states sealing the cells 22, but the cells 22 are not specifically required to be sealed. As illustrated in FIG. 5, by way of example, first conductive thin films 131 may be disposed on inner walls of the cells 22 instead of forming the first conductive plugs 31, and second conductive thin films 132 may be disposed on inner walls of the cells 22 instead of forming the second conductive plugs 32. The plurality of first conductive films 131 successively arranged in the diagonal direction are electrically interconnected via a first conductive line 131a obliquely continuously extending through the partition walls 24. Furthermore, the plurality of second conductive films 132 successively arranged in the diagonal direction are electrically interconnected via a second conductive line 132a obliquely continuously extending through the partition walls 24. Also in this case, similar advantageous effects to those in the above-described embodiment can be obtained. In addition, a pressure loss of the exhaust gas passing through the honeycomb filter 20 can be reduced in comparison with the above-described embodiment.

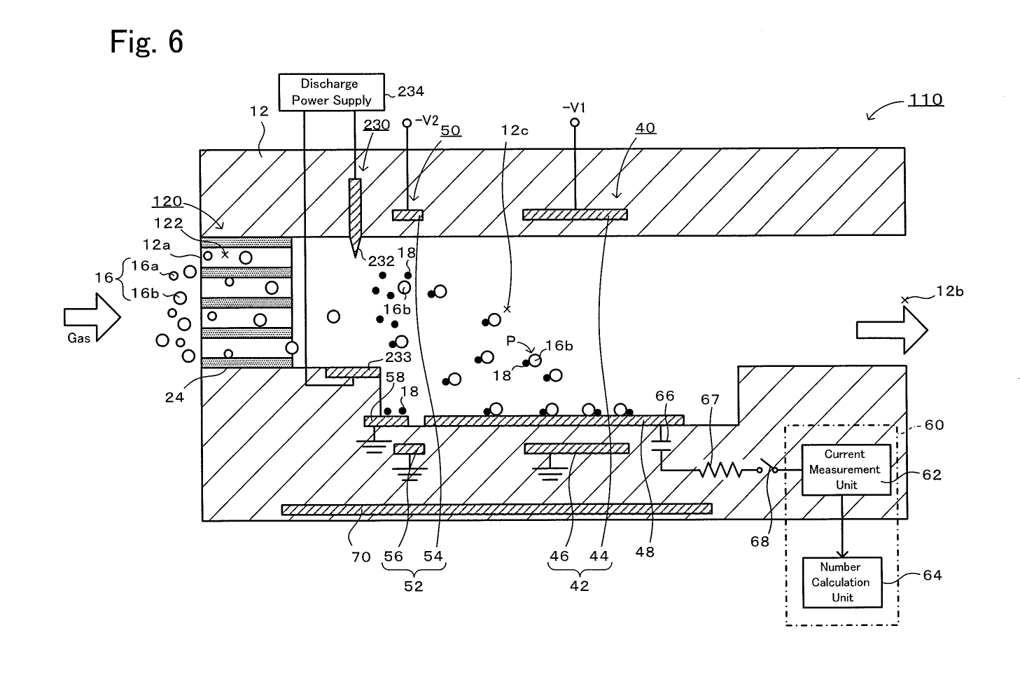

In the above-described embodiment, the charge adding unit 30 is formed integrally with the honeycomb filter 20 on the downstream side, but those two components may be constituted separately from each other. One example of such a case is illustrated in FIG. 6. A fine-particle number detector 110 illustrated in FIG. 6 is similar to the fine-particle number detector 10 according to the above-described embodiment except for arranging, instead of the honeycomb filter 20, a honeycomb filter 120 not including the charge adding unit 30, and for arranging a charge adding element 230 between the honeycomb filter 120 and the hollow portion 12c. Taking into account the above point, similar components in the fine-particle number detector 110 to those in the fine-particle number detector 10 are denoted by the same reference signs, and description of those components is omitted. The honeycomb filter 120 is a honeycomb structure body made of ceramic and has many cells 122 penetrating through the honeycomb filter 120 along a gas flowing direction. The charge adding element 230 includes a needle electrode 232 and a counter electrode 233 that is disposed opposite to the needle electrode 232. The needle electrode 232 and the counter electrode 233 are connected to a discharge power supply 234 that applies a voltage Vp (e.g., a pulse voltage). When the voltage Vp is applied between the needle electrode 232 and the counter electrode 233, the charge adding element 230 generates aerial discharge due to a potential difference between both the electrodes. While the exhaust gas having passed through the honeycomb filter 120 passes across the aerial discharge, the charges 18 are added to the fine particles 16 (mainly, the non-ultrafine particles 16b) in the exhaust gas, and these particles become the charged fine particles P. According to the fine-particle number detector 110, as in the above-described embodiment, since the ultrafine particles 16a are selectively removed by the honeycomb filter 120 disposed on the upstream side of the charge adding element 230, the number of fine particles included as the measurement target in car exhaust gas can be detected with high accuracy regardless of the temperature of the exhaust gas.

Although the charge adding element 230 is constituted by the needle electrode 232 and the counter electrode 233, it may be constituted in a different way. For instance, the aerial discharge may be generated by disposing a discharge electrode on one surface of a dielectric layer, disposing a ground electrode on the other surface or inside the dielectric layer, and by supplying low-frequency or direct-current power to generate a high potential difference between the discharge electrode and the ground electrode.

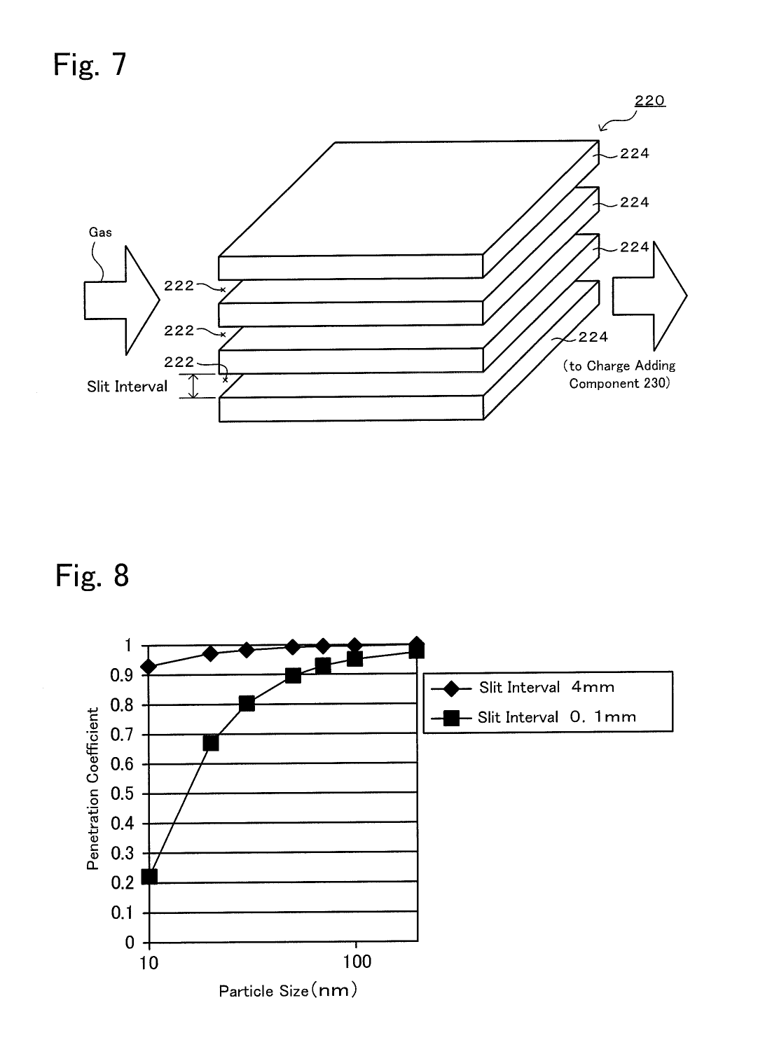

As illustrated in FIG. 7, a filter 220 including slits 222 may be used instead of the honeycomb filter 120 in the fine-particle number detector 110 of FIG. 6. In the filter 220, the slits 222 are formed by arranging a plurality of metal plates 224 at predetermined intervals. The slit interval is set to a range of not less than 0.01 mm and less than 0.2 mm. The reason why the slit interval is set to be not less than 0.01 mm resides in avoiding a pressure loss from becoming too high, and the reason why the slit interval is set to be less than 0.2 mm resides in making the ultrafine particles under the Brown motion more easily adsorbed on the metal plates 224. FIG. 8 is a graph plotting penetration characteristics of the filter 220 when the slit interval is set to 4 mm and 0.1 mm. When the slit interval is 4 mm, fine particles in gas penetrate through the slits 222 at high penetration coefficients regardless of the particle size because the slit interval is too wide. On the other hand, when the slit interval is 0.1 mm, many of non-ultrafine particles advance in the gas flowing direction and pass through the filter 220 without being adsorbed on wall surfaces of the metal plates 224 because the Brown motion is moderate. However, many of ultrafine particles are diffused toward and adsorbed on the wall surfaces of the metal plates 224 rather than advancing in the gas flowing direction because the Brown motion is active. When the slit interval is 0.1 mm, the penetration coefficient of fine particles having the particle size of 10 nm is about 0.2, the penetration coefficient of fine particles having the particle size of 23 nm is about 0.7, and the penetration coefficient of fine particles having the particle size of 50 nm of more is not lower than 0.8. Hence the filter 220 can selectively remove the ultrafine particles 16a. Thus, also in the case of using the filter 220 illustrated in FIG. 7 instead of the honeycomb filter 120 in the fine-particle number detector 110 of FIG. 6, since the ultrafine particles are selectively removed by the filter 220 disposed on the upstream side of the charge adding element 230, the number of fine particles included as the measurement target in car exhaust gas can be detected with high accuracy regardless of the temperature of the exhaust gas. The penetration characteristics plotted in FIG. 8 are more closely in conformity with the PMP definitions than those plotted in FIG. 3. The filter 220 is also preferably made of ceramic as in the honeycomb filter 120.

In the above-described embodiment, the number of fine particles 16 to which the charges 18 are added is measured, but the number of fine particles 16 to which the charges 18 are added may be determined by subtracting the number of charges 18, which have not been added to the fine particles 16, from the total number of generated charges 18 (see, e.g., third embodiment in WO2015/146456). More specifically, the number (N1) of charges 18 generated in the charge adding unit 30 is first counted using gas in which the fine particles 16 are hardly present. Then, the number (N2) of ones among the charges 18 generated in the charge adding unit 30, those ones having not been added to the fine particles 16, is counted using gas that includes the fine particles 16. The number (N3) of ones among the charges 18 generated in the charge adding unit 30, those ones having been added to the fine particles 16, can be determined from N3=N1−N2. A value (N) resulting from dividing N3 by an average value NA of the number of charges added to each fine particle 16 is substantially equal to the number of fine particles 16, and it can be determined from N=N3/NA. The number of fine particles included in gas can also be measured in such a manner.

In the above-described embodiment, the predetermined particle size is set to 23 nm and the ultrafine particles 16a not larger than the predetermined particle size as an upper limit are selectively removed by the honeycomb filter 20, but the predetermined particle size may be set to 25 nm, 20 nm, 15 nm, or 10 nm. In such a case, the wall thickness, the cell density, the gas-flowing-direction length, etc. of the honeycomb filter 20 may be changed as appropriate depending on a value of the predetermined particle size.

Although the above-described embodiment illustrates, by way of example, the fine-particle number detector 10 for measuring the number of fine particles in gas, whether the number of fine particles falls within a preset range (e.g., whether the number of fine particles exceeds a preset threshold) may be determined instead of measuring the number of fine particles in gas.

In the above-described embodiment, the fine-particle number detector 10 includes the extra-charge removing device 50, but the extra-charge removing device 50 may be omitted.

The present application claims priority from Japanese Patent Application No. 2016-137414, file on Jul. 12, 2016, the entire contents of which are incorporated herein by reference.

What is claimed is:

1. A fine-particle number detector comprising:
a filter selectively removing, from among fine particles in car exhaust gas introduced into a gas passage pipe, ultrafine particles not larger than a predetermined particle size that is previously set as an upper limit within a range of 25 nm or less;
a charge adding device adding charges to the fine particles in the exhaust gas having passed through the filter, and producing charged fine particles; and
a detection device detecting the number of fine particles in the exhaust gas having passed through the filter on the basis of an amount of charges of the charged fine particles or an amount of charges having not been added to the fine particles.

2. The fine-particle number detector according to claim 1, wherein the filter is a honeycomb filter including many cells.

3. The fine-particle number detector according to claim 2, wherein the charge adding device includes a dielectric layer made of a wall between adjacent ones among the many cells on the downstream side in a flowing direction of the exhaust gas, and a discharge electrode and a ground electrode arranged with the dielectric layer interposed therebetween.

4. The fine-particle number detector according to claim 3, wherein the charge adding device has a structure that, looking at quadrangular cross-sections of four ones among the many cells, the four ones being consisted of vertically arranged two cells and horizontally arranged two cells, one of the two diagonally arranged cells is sealed to serve as a discharge electrode, the other cell is sealed to serve as a ground electrode, and the remaining two cells serve as gas flow paths.

5. The fine-particle number detector according to claim 1, wherein the filter includes slits, and an interval between the slits is set to a range of not less than 0.01 mm and less than 0.2 mm.

6. The fine-particle number detector according to claim 1, wherein the filter is made of ceramic.
